(19) United States
(12) Patent Application Publication
(10) Pub. No.: US 2015/0208428 A1
(43) Pub. Date: Jul. 23, 2015

(54) METHOD AND APPARATUS FOR INTERFERENCE CANCELLATION

(71) Applicant: LG ELECTRONICS INC., Seoul (KR)

(72) Inventors: Hanjun PARK, Seoul (KR); Kijun KIM, Seoul (KR); Yunjung YI, Seoul (KR)

(73) Assignee: LG ELECTRONICS INC.

(21) Appl. No.: 14/597,562

(22) Filed: Jan. 15, 2015

Related U.S. Application Data
(60) Provisional application No. 61/928,411, filed on Jan. 17, 2014.

(51) Int. Cl. H04W 72/08; H04L 5/00

(52) U.S. Cl. CPC H04W 72/082; H04L 5/0035

(57) ABSTRACT

Disclosed are a method and apparatus for interference cancellation. A method for receiving information for interference cancellation in a wireless communication system, according to an embodiment of the present invention, is performed by a terminal and includes receiving information on an interference configuration set related to characteristics of an interference signal, from a serving base station (BS); receiving an indicator indicating one interference configuration of the interference configuration set from an interfering BS; and performing cancellation of the interference signal using the indicated interference configuration. The interference configuration set is composed of one or more interference configurations each including a plurality of fields indicating the characteristics of the interference signal.

Pursuant to 35 U.S.C. §119(e), this application claims the benefit of U.S. Provisional Patent Application Ser. No. 61/928,411, filed on Jan. 17, 2014, the contents of which are hereby incorporated by reference herein in its entirety.

### BACKGROUND OF THE INVENTION

1. Field of the Invention

The present invention relates to a wireless communication system and, more particularly, to a method and apparatus for interference cancellation.

2. Discussion of the Related Art

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### SUMMARY OF THE INVENTION

Accordingly, the present invention is directed to a method for requesting information for interference cancellation and performing interference cancellation using the information that substantially obviates one or more problems due to limitations and disadvantages of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for receiving information for interference cancellation in a wireless communication system is performed by a terminal and includes receiving information on an interference configuration set related to characteristics of an interference signal, from a serving base station (BS), receiving an indicator indicating one interference configuration of the interference configuration set from an interfering BS, and performing cancellation of the interference signal using the indicated interference configuration, wherein the interference configuration set is composed of one or more interference configurations each including a plurality of fields indicating the characteristics of the interference signal.

Alternatively or additionally, the interference configuration set may be configured per subframe set or per specific frequency resource unit.

Alternatively or additionally, the interference configuration may include information on two or more interference signals having different characteristics.

Alternatively or additionally, the plurality of fields includes a field indicating a null value.

Alternatively or additionally, the method may further include receiving information on a valid time of the indicated interference configuration from the serving BS, and the indicated interference configuration may be used to cancel the interference signal only during the valid time.

Alternatively or additionally, the method may further include receiving information on a period in which the indicator is transmitted or information on a subframe in which the indicator is transmitted, from the serving BS.

Alternatively or additionally, the information on the interference configuration set may be received through semi-static signaling.

Alternatively or additionally, the indicator may be received through dynamic signaling.

In another aspect of the present invention, a terminal configured to receive information for interference cancellation in a wireless communication system includes a radio frequency (RF) unit, and a processor configured to control the RF unit, wherein the processor is configured to receive information on an interference configuration set related to characteristics of an interference signal, from a serving base station (BS), to receive an indicator indicating one interference configuration of the interference configuration set from an interfering BS, and to perform cancellation of the interference signal using the indicated interference configuration, and wherein the interference configuration set is composed of one or more interference configurations each including a plurality of fields indicating the characteristics of the interference signal.

Alternatively or additionally, the interference configuration set may be configured per subframe set or per specific frequency resource unit.

Alternatively or additionally, the interference configuration may include information on two or more interference signals having different characteristics.

Alternatively or additionally, the plurality of fields includes indicate a field indicating a null value.

Alternatively or additionally, the processor may be further configured to receive information on a valid time of the indicated interference configuration from the serving BS, and the indicated interference configuration may be used to cancel the interference signal only during the valid time.

Alternatively or additionally, the processor may be further configured to receive information on a period in which the indicator is transmitted or information on a subframe in which the indicator is transmitted, from the serving BS.

Alternatively or additionally, the information on the interference configuration set may be received through semi-static signaling.

Alternatively or additionally, the indicator may be received through dynamic signaling.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an exemplary radio frame structure in a wireless communication system;

FIG. 2 illustrates an exemplary structure of a Downlink/Uplink (DL/UL) slot in a wireless communication system;

FIG. 3 illustrates an exemplary structure of a DL subframe in a 3rd Generation Partnership project (3GPP) Long Term Evolution (LTE)/LTE-Advanced (LTE-A) system;

FIG. 4 illustrates an exemplary structure of a UL subframe in the 3GPP LTE/LTE-A system;

FIG. 5 illustrates an interference environment in a multi-cell environment;

FIG. 6 illustrates signaling of an interference configuration set according to an embodiment of the present invention;

FIG. 7 illustrates a bit field for a dynamic signal indicating an interference configuration set according to an embodiment of the present invention;

FIG. 8 illustrates a valid time of a dynamic signal indicating an interference configuration set according to an embodiment of the present invention;

FIG. 9 illustrates signaling of an interference configuration set and a procedure related thereto according to an embodiment of the present invention; and

FIG. 10 is a block diagram of apparatuses for implementing an embodiment(s) of the present invention.

### DETAILED DESCRIPTION OF THE INVENTION

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming) DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

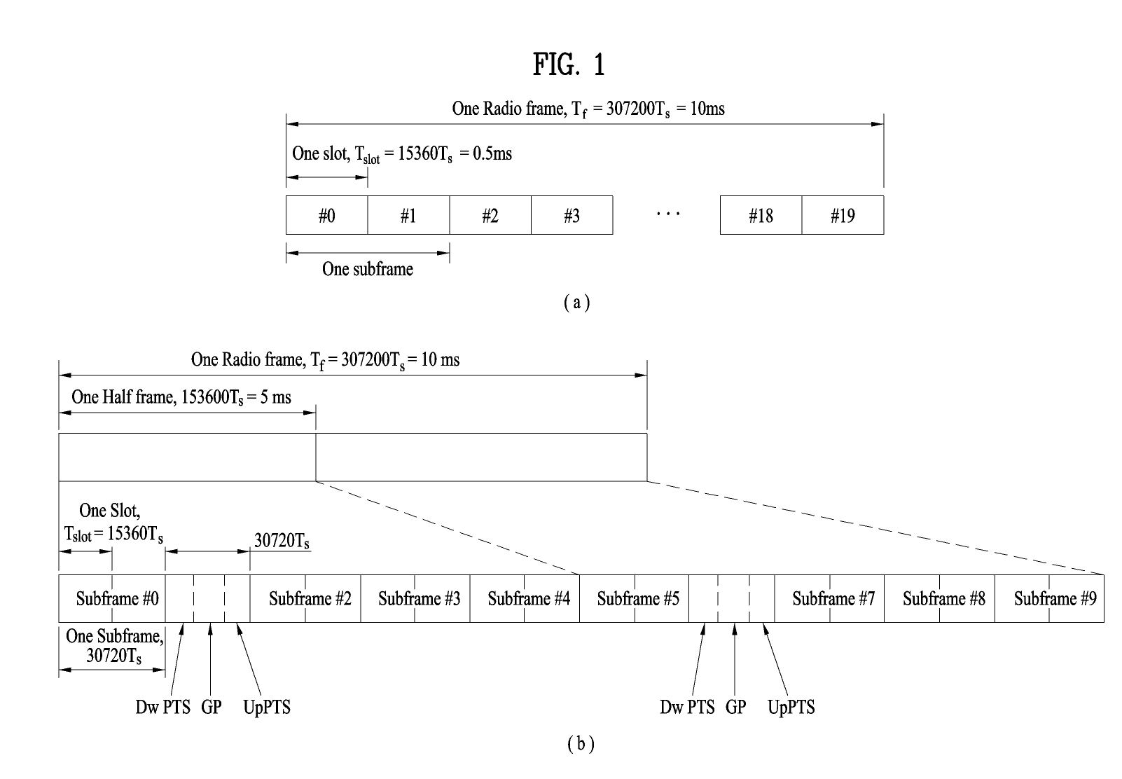

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| | to-Uplink | | | | | | | | | | |
| | Switch- | | | | | | | | | | |
| DL-UL | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal cyclic | Extended | | Normal | Extended |
| subframe | | prefix in | cyclic prefix | | cyclic prefix | cyclic prefix |
| configuration | DwPTS | uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

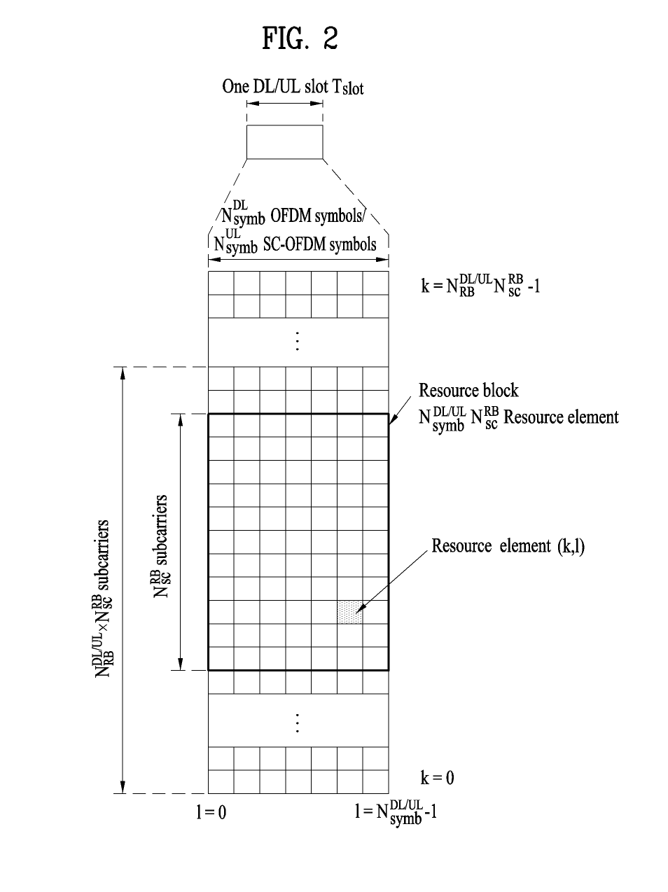

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g., 7) consecutive OFDM symbols in the time domain and N_{sc}^{RB} (e.g., 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 in the frequency domain and 1 is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

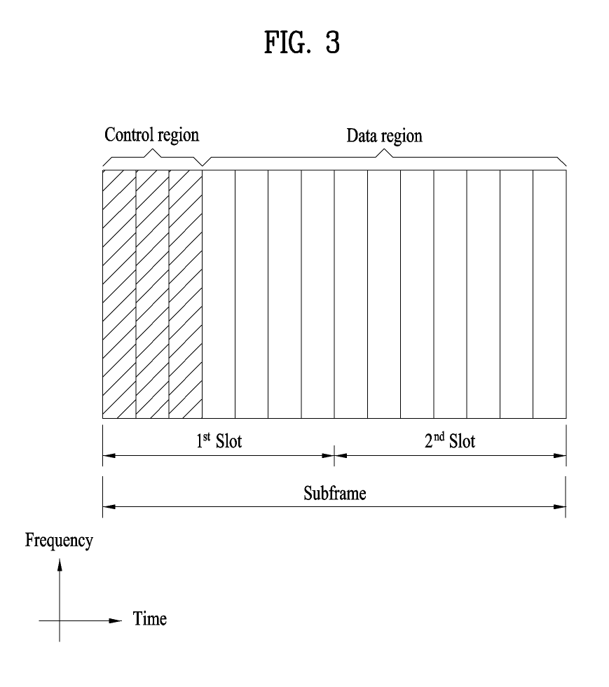

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

Search Space

| | Aggregation | Size | Number of PDCCH |
|---|---|---|---|
| Type | Level L | [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g., frequency position) of “B” and transmission format information (e.g., transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

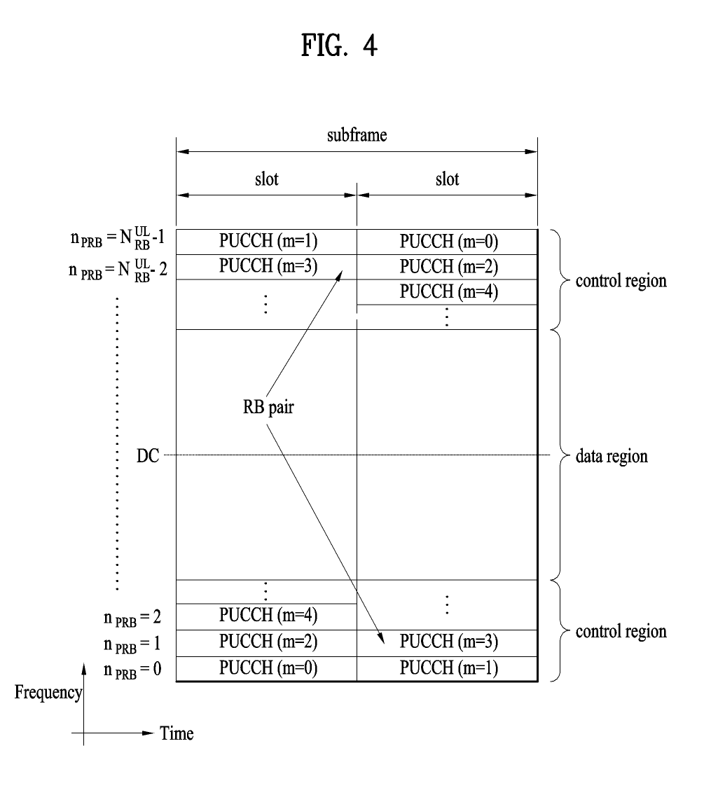

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.

Scheduling Request (SR): This is information used to request a UL-SCH resource and is transmitted using On-Off Keying (OOK) scheme.

HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (NACK), discontinuous transmission (DTX) and NACK/DTX. Here, the term HARQ-ACK is used interchangeably with the term HARQ ACK/NACK and ACK/NACK.

Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon. Table 4 shows the mapping relationship between PUCCH formats and UCI in LTE/LTE-A.

TABLE 4

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One |
| | | | SR + ACK/NACK | codeword |
| 1b | QPSK | 2 | ACK/NACK or | Two |
| | | | SR + ACK/NACK | codeword |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

Reference Signal (RS)

When a packet is transmitted in a wireless communication system, signal distortion may occur during transmission since the packet is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is called a pilot signal or a reference signal.

When data is transmitted/received using multiple antennas, the receiver can receive a correct signal only when the receiver is aware of a channel state between each transmit antenna and each receive antenna. Accordingly, a reference signal needs to be provided per transmit antenna, more specifically, per antenna port.

Reference signals can be classified into an uplink reference signal and a downlink reference signal. In LTE, the uplink reference signal includes:

i) a demodulation reference signal (DMRS) for channel estimation for coherent demodulation of information transmitted through a PUSCH and a PUCCH; and

ii) a sounding reference signal (SRS) used for an eNB to measure uplink channel quality at a frequency of a different network.

The downlink reference signal includes:

i) a cell-specific reference signal (CRS) shared by all UEs in a cell;

ii) a UE-specific reference signal for a specific UE only;

iii) a DMRS transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

Reference signals can be classified into a reference signal for channel information acquisition and a reference signal for data demodulation. The former needs to be transmitted in a wide band as it is used for a UE to acquire channel information on downlink transmission and received by a UE even if the UE does not receive downlink data in a specific subframe. This reference signal is used even in a handover situation. The latter is transmitted along with a corresponding resource by an eNB when the eNB transmits a downlink signal and is used for a UE to demodulate data through channel measurement. This reference signal needs to be transmitted in a region in which data is transmitted.

CoMP (Coordinated Multiple Point Transmission and Reception)

In accordance with the improved system throughput requirements of the 3GPP LTE-A system, CoMP transmission/reception technology (also referred to as Co-MIMO, collaborative MIMO or network MIMO) has recently been proposed. The CoMP technology can increase throughput of a UE located at a cell edge and also increase average sector throughput.

In general, in a multi-cell environment in which a frequency reuse factor is 1, the performance of the UE located on the cell edge and average sector throughput may be reduced due to Inter-Cell Interference (ICI). In order to reduce the ICI, in the legacy LTE system, a method of enabling the UE located at the cell edge to have appropriate throughput and performance using a simple passive method such as Fractional Frequency Reuse (FFR) through the UE-specific power control in the environment restricted by interference is applied. However, rather than decreasing the use of frequency resources per cell, it is preferable that the ICI is reduced or the UE reuses the ICI as a desired signal. In order to accomplish the above object, a CoMP transmission scheme may be applied.

The CoMP scheme applicable to the downlink may be largely classified into a Joint Processing (JP) scheme and a Coordinated Scheduling/Beamforming (CS/CB) scheme.

In the JP scheme, each point (eNB) of a CoMP unit may use data. The CoMP unit refers to a set of eNBs used in the CoMP scheme. The JP scheme may be classified into a joint transmission scheme and a dynamic cell selection scheme.

The joint transmission scheme refers to a scheme for transmitting a PDSCH from a plurality of points (a part or the whole of the CoMP unit). That is, data transmitted to a single UE may be simultaneously transmitted from a plurality of transmission points. According to the joint transmission scheme, it is possible to coherently or non-coherently improve the quality of the received signals and to actively eliminate interference with another UE.

The dynamic cell selection scheme refers to a scheme for transmitting a PDSCH from one point (of the CoMP unit). That is, data transmitted to a single UE at a specific time is transmitted from one point and the other points in the cooperative unit at that time do not transmit data to the UE. The point for transmitting the data to the UE may be dynamically selected.

According to the CS/CB scheme, the CoMP units may cooperatively perform beamforming of data transmission to a single UE. Although only a serving cell transmits the data, user scheduling/beamforming may be determined by coordination of the cells of the CoMP unit.

In uplink, coordinated multi-point reception refers to reception of a signal transmitted by coordination of a plurality of geographically separated points. The CoMP scheme applicable to the uplink may be classified into Joint Reception (JR) and Coordinated Scheduling/Beamforming (CS/CB).

The JR scheme indicates that a plurality of reception points receives a signal transmitted through a PUSCH, the CS/CB scheme indicates that only one point receives a PUSCH, and user scheduling/beamforming is determined by the coordination of the cells of the CoMP unit.

In addition, one case in which there are multiple UL points (i.e., multiple Rx points) is referred to as UL CoMP, and the other case in which there are multiple DL points (i.e., multiple Tx points) is referred to as DL CoMP.

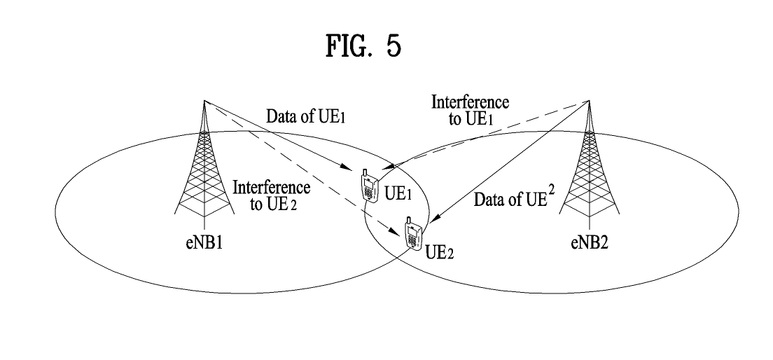

For an advanced wireless communication system such as LTE Rel-12, a network assisted interference cancellation and suppression (NAICS) scheme for cancelling interference from a neighboring cell by a UE based on the help of a network is under discussion. FIG. 5 illustrates an interference environment in which data transmitted from eNB₁ to UE₁ provides interference to UE₂ and data transmitted from eNB₂ to UE₂ provides interference to UE₁ when UE₁ is served by eNB₁ and UE₂ is served by eNB₂ in an LTE system. In FIG. 5, when UE₁ or UE₂ performs the NAICS scheme, interference may be mitigated if the corresponding UE attempts to demodulate or decode data of a neighboring eNB and then successfully cancels interference data from the received signal.

Interference-related information is provided from a network to a UE to help NAICS. The interference-related information may include RS type, rank indicator (RI), transmitted precoding matrix indicator (TPMI), resource allocation (RA), modulation order, P_{A}, etc. for demodulation of an interfering eNB. In this case, the interference-related information is preferably transmitted to UEs performing NAICS (hereinafter referred to as “NAICS UEs”) in the form of dynamic signaling. However, NAICS can be performed in an environment in which eNBs are connected with non-ideal backhaul (NIB) and thus CoMP operation based on ideal backhaul is not easily performed. Accordingly, the interfering eNB may directly transmit a dynamic signal to the NAICS UEs to support information on interference data in the form of dynamic signaling. The dynamic signal is used only to help the NAICS UEs for a neighboring eNB in view of the interfering eNB, the amount of load for signaling is preferably minimized

As such, in the present invention, an interference configuration expressed as a combination of different types of the interference-related information may be defined, and the interfering eNB may configure an interference configuration set per frequency resource unit (e.g., PRB) to the NAICS UEs, and signal information indicating which interference configuration is utilized per frequency resource unit to the NAICS UEs using a dynamic signal. In this case, the interfering eNB may preliminarily configure time information indicating how long the dynamic signal indicating the interference configuration is valid from a reception time thereof, to the NAICS UEs, and may transmit the dynamic signal in a period greater than the valid time. Furthermore, signaling of information indicating in which subframe or frequency resource the signaled interference configuration is useful may be additionally considered. For example, two cases such as cancellation of interference from a macro cell (or eNB) and cancellation of interference from a small cell (or eNB) can be considered. Since a macro cell simultaneously schedules a large number of UEs, it is not easy to semi-statically signal the interference configuration to the UEs and to equally apply the same in every subframe. Accordingly, for resource coordination with small cells, subframes are divided by configuring almost blank subframes (ABSs), etc., and an interference configuration applicable to such situation can vary. On the other hand, for interference cancellation in a small cell, since a smaller number of UEs are simultaneously served by the small cell compared to the macro cell, the influence of such coordination can be maintained for a long time.

A description is now given of operations of the present invention using an LTE system as an example. However, the operations may be extended to an arbitrary wireless communication system for providing interference-related information to NAICS UEs.

Interference Configuration

A description is now given of a method for defining an interference configuration expressed as a combination of a plurality of types of interference-related information (e.g., RS type, PMI, RI, modulation order and P_{A}), according to an embodiment of the present invention. The interference configuration may represent characteristics of a single interference datum, or characteristics of interference data based on a plurality of PDSCHs which can be present for a certain period of time. For example, when RS type, PMI, RI, modulation order and P_{A} are considered as characteristics of interference data, the interference configuration may represent information on a single interference datum as shown in the following table.

TABLE 5

| | | | | Modulation | |
|---|---|---|---|---|---|
| | RS type | PMI | RI | order | P_{A} |
| Interference | CRS | PMI₁ | Rank 2 | 16QAM | −4.77 dB |
| configuration 0 | | | | | |

In the above table, the RS type refers to the type of an RS for demodulation, and may be a cell-specific reference signal (CRS) or a demodulation reference signal (DM-RS) in an LTE system according to an embodiment of the present invention. Alternatively, the interference configuration may represent characteristics of 2 interference data as shown in the following table.

TABLE 6

| | | | | Modulation | |
|---|---|---|---|---|---|
| | RS type | PMI | RI | order | P_{A} |
| Interference | CRS | PMI₁ | Rank 2 | 16QAM | −4.77 dB |
| configuration 0 | CRS | TxD | Rank 1 | QPSK | −4.77 dB |

The example of Table 6 means that the interference data can be transmitted using a MIMO scheme scheduled in DCI format 2 based on TM4, or using a Tx diversity scheme scheduled in DCI format 1A which is a fallback mode of TM4 in a specific resource region. In addition to the above examples, one interference configuration may represent characteristics of one or more interference data. Furthermore, the interference configuration proposed by the present invention may designate a null state for specific interference-related information.

TABLE 7

| | | | | Modulation | |
|---|---|---|---|---|---|
| | RS type | PMI | RI | order | P_{A} |
| Interference | CRS | Null | Rank 2 | 16QAM | −4.77 dB |
| configuration 0 | | | | | |

That is, if the PMI is designated as a null state as shown in Table 7, it indicates that an interfering eNB determines an arbitrary PMI to schedule interference data. If signaling is performed on a frequency basis, for a case in which data scheduling is not performed on a specific frequency, characteristics of one interference datum within the interference configuration may indicate a state having no interference data scheduling (i.e., a reserved state). Alternatively, a dynamic signal indicating interference-related information and a dynamic signal indicating whether interference data is scheduled may be separately provided. For example, a dynamic signal about variations in interference-related information may be transmitted to a UE in a period of 10 msec while a dynamic signal indicating whether interference data is scheduled per PRB or PRG may be transmitted per subframe. However, if the interference configuration specifies specific interference-related information, the interfering eNB should be guaranteed to transmit the interference data in the same manner as the interference-related information specified in the interference configuration at a specific timing and in a specific frequency resource region. In this case, if one interference configuration represents a plurality of transmission schemes of interference data as shown in Table 6, this means that the interfering eNB transmits the interference data using one of the transmission schemes.

Interference Configuration Set

A description is now given of a method for configuring a plurality of interference configurations as an interference configuration set for a NAICS UE, according to an embodiment of the present invention. An interference configuration is used to represent characteristics of interference data, and a plurality of interference configurations may appropriately represent a candidate group of available interference data transmission schemes. Accordingly, the present invention defines an interference configuration set composed of a plurality of interference configurations as shown in the following table.

TABLE 8

| | | | | Modulation | |
|---|---|---|---|---|---|
| | RS type | PMI | RI | order | P_{A} |
| Interference | DM-RS | Null | Rank 1 | QPSK | Null |
| configuration 0 | DM-RS | Null | Rank 2 | 16QAM | Null |
| Interference | CRS | Null | Rank 2 | 16QAM | −4.77 dB |
| configuration 1 | CRS | TxD | Rank 1 | QPSK | −4.77 dB |

Table 8 shows an interference data transmission scheme based on DM-RS, e.g., TM9 or TM10 (interference configuration 0) and an interference data transmission scheme based on CRS, e.g., TM4 or fallback mode (interference configuration 1). The interference configuration set may be configured by an interfering eNB and transmitted to a serving eNB of the NAICS UE through backhaul signaling. In this case, the interference configuration set may be configured for a total system band or per frequency resource unit (e.g., PRB or RBG). Alternatively, a plurality of subframe sets are configured and an interference configuration set corresponding to each subframe set may be configured. This configuration per subframe set may also be configured for a total band or per frequency resource unit. The UE may follow assumptions described below in a subframe or a frequency resource for which the interference configuration set is not configured.

Case 1: Since the UE does not have interference-related information, the UE performs blind detection on interference data within the range of capability thereof. In this case, cancellation of interference data can be reflected in a CQI report or not.

Case 2: Since the UE does not have interference-related information, the UE does not perform interference cancellation.

Case 3: The UE assumes a default interference configuration, and performs interference cancellation based on the default interference configuration. For example, the default interference configuration may be as shown below.

TABLE 9

| | | | Modulation | |
|---|---|---|---|---|
| RS type | PMI | RI | order | P_{A} |
| CRS | TxD | Rank 1 | QPSK | −4.77 dB |

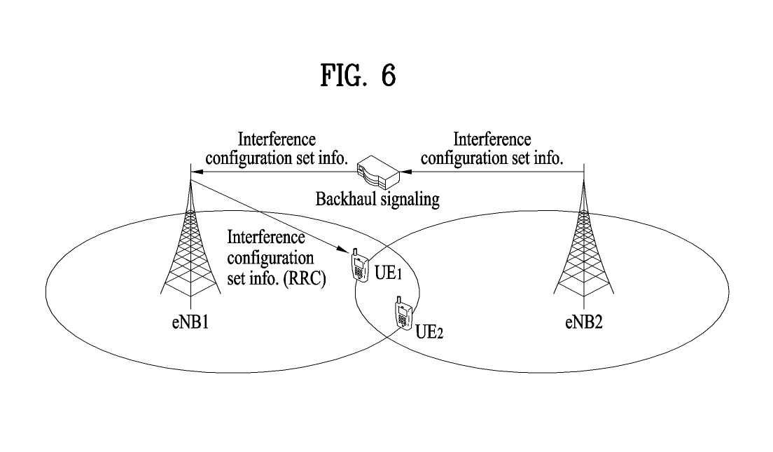

FIG. 6 illustrates signaling of an interference configuration set according to an embodiment of the present invention. The interference configuration set may be transmit ted from an interfering eNB (eNB) to a serving eNB (eNB₁) of a NAICS UE through backhaul signaling. The serving eNB may transmit the interference configuration set to the NAICS UE through higher layer signaling, e.g., RRC signaling. In this case, the interference configuration set may be selectively transmitted to a NAICS UE having reported that RSRP of t he interfering eNB is high.

Dynamic Signaling of Interference Configuration

According to an embodiment of the present invention, when a plurality of interference configurations are configured as an interference configuration set per frequency resource unit for a NAICS UE, an interfering eNB having configured the interference configuration set may transmit a dynamic signal indicating one interference configuration of the interference configuration set per frequency resource unit, to the NAICS UE. A method for performing network coordination between cells (or eNBs) through semi-static signaling is under discussion as a method for performing NAICS in LTE Rel-12. This network coordination is discussed in the form of limiting parts of a data transmission scheme, e.g., TM, modulation order, resource allocation, etc., to allow the NAICS UE to better detect interference data. The network coordination can help the NAICS UE, but can restrict a data transmission scheme to a non-NAICS UE and thus may not be preferable to a UE or an eNB serving the UE. Accordingly, in the present invention, an interfering eNB may directly transmit information on interference data through dynamic signaling in the form of indicating one interference configuration of an interference configuration set. As such, signaling load may be reduced and flexibility based on the interference configuration may be guaranteed.

Bits Field for Indication of Interference Configuration

A bit field composed of M bits may be defined for each frequency resource unit, and may represent 2^{M} interference configurations. The following table shows an example when M is 2.

TABLE 10

| Bits field for | |
|---|---|
| k-th PRB | Interference configuration |
| 00 | Interference configuration 0 configured by |
| | higher layer signaling |
| 01 | Interference configuration 1 configured by |
| | higher layer signaling |
| 10 | Interference configuration 2 configured by |
| | higher layer signaling |
| 11 | Interference configuration 3 configured by |
| | higher layer signaling |

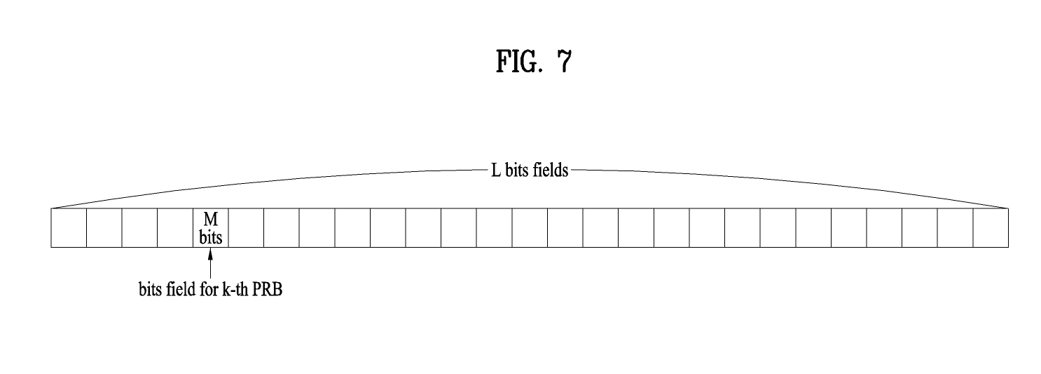

When a total frequency resource region has L frequency resource units (e.g., PRBs or RBGs), each dynamic signal for an interference configuration may indicate M bits per frequency resource unit. FIG. 7 illustrates a bit field of the dynamic signal. Accordingly, the dynamic signal has a payload of L*M bits.

Valid Time for Dynamic Signaling of Interference Configuration

The above-described dynamic signal is preferably not always transmitted. That is, an interfering eNB may preliminarily configure information on a valid time during which an interference configuration indicated by a dynamic signal is guaranteed, for a NAICS UE, and the NAICS UE may utilize the interference configuration indicated by the dynamic signal to detect interference data during the valid time from a time when the dynamic signal is received.

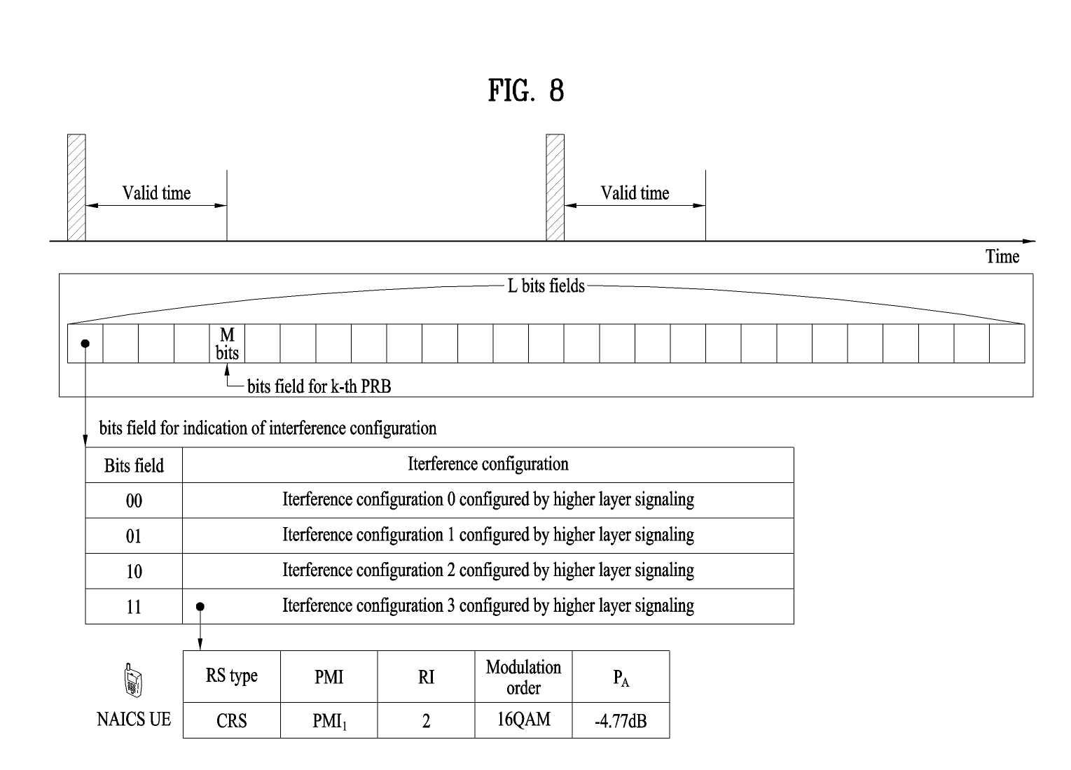

FIG. 8 illustrates a dynamic signal, a valid time of which is configured according to an embodiment of the present invention. When an interference configuration is specified per subframe set, a number of valid times corresponding to the number of subframes m ay be configured, and only the number of subframes belonging to a corresponding subframe set may be counted.

In this case, to prevent a NAICS UE from always detecting the dynamic signal, a serving eNB may transmit the dynamic signal in a regular period and signal information on the period to the NAIC UE. Alternatively, a subframe in which the dynamic signal is transmitted can be preconfigured. If the dynamic signal is not received in such a subframe, the UE regards the corresponding dynamic signal as missing, and may use the most recently received dynamic signal by assuming that the most recently received dynamic signal is still valid, or may perform interference cancellation by assuming that no interference-related information is present.

When an interference configuration set is configured for a plurality of subframe sets, the subframe in which the dynamic signal is transmitted may be configured per subframe set. Accordingly, an interfering eNB may transmit information on the dynamic signal, i.e., a valid time and a period of the dynamic signal or the subframe in which the dynamic signal is transmitted, to the serving eNB of the NAICS UE through backhaul signaling, and the serving eNB may transmit the information on the dynamic signal to the NAICS UE through higher layer signaling, e.g., RRC signaling.

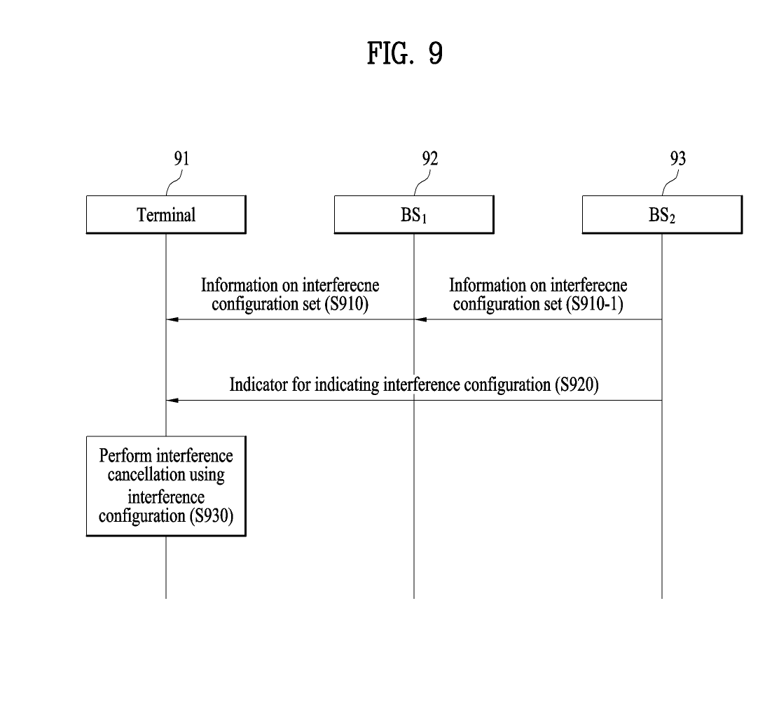

FIG. 9 illustrates operation for receiving an interference configuration and cancelling interference using the interference configuration, according to an embodiment of the present invention.

A terminal 91 may receive information on an interference configuration set related to characteristics of an interference signal, from BS₁ 92 which is a serving BS (S910). The BS₁ 92 might have been received the information on the interference configuration set from BS₂ 93 (S910-1). The BS₂ 93 corresponds to an interfering BS for transmitting the interference signal. The interference configuration set is composed of one or more interference configurations each including a plurality of fields indicating characteristics of the interference signal. Furthermore, the interference configuration set may be configured per subframe set or per specific frequency resource unit.

For example, the interference configuration set may be a set of the interference configurations shown in Table 8.

The terminal 91 may receive an indicator of one interference configuration of the interference configuration set from the BS₂ 93 (S920). The indicator may correspond to the bit field shown in Table 10. After that, the terminal 91 may cancel the interference signal using the indicated interference configuration (S930).

The terminal 91 may additionally receive information on a valid time of the indicated interference configuration from the serving BS 92. As such, the indicated interference configuration is valid only during the valid time, and thus may be used to cancel the interference signal only during the valid time. That is, this means that the BS₂ 93 guarantees downlink transmission based on the interference configuration only during the valid time.

Furthermore, the terminal 91 may receive information on a period in which the indicator is transmitted or information on a subframe in which the indicator is transmitted, from the serving BS 92. As such, the number of times that the terminal 91 performs blind detection to detect the indicator may be reduced.

In addition, the information on the interference configuration set may be transmitted to the terminal 91 through semi-static signaling. If the information on the interference configuration set is transmitted through dynamic signaling, a relatively large amount of information should be dynamically transmitted and thus the terminal 91 and the serving BS 92 can be overburdened. Accordingly, the information on the interference configuration set may be transmitted through semi-static signaling while the indicator may be transmitted through dynamic signaling.

While the operation proposed by the present invention has been described above with reference to FIG. 9, those skilled in the art will appreciate that at least one of the afore-described embodiments is applicable to the operation related to FIG. 9.

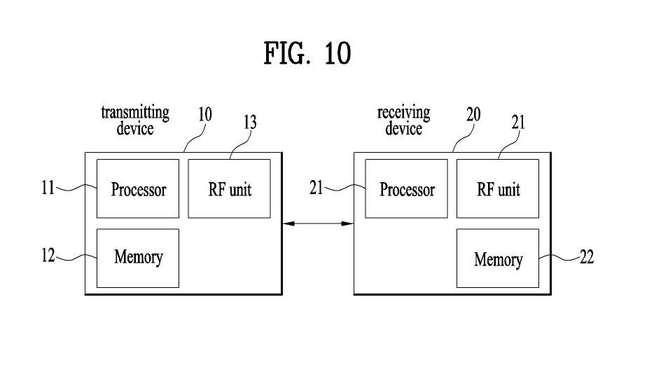

FIG. 10 is a block diagram of a transmitting device 10 and a receiving device 20 configured to implement exemplary embodiments of the present invention. Referring to FIG. 10, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nt (where Nt is a positive integer) transmit antennas.

A signal processing process of the receiving device 20 is the reverse of the signal processing process of the transmitting device 10. Under the control of the processor 21, the RF unit 23 of the receiving device 10 receives RF signals transmitted by the transmitting device 10. The RF unit 23 may include Nr receive antennas and frequency down-converts each signal received through receive antennas into a baseband signal. The RF unit 23 may include an oscillator for frequency down-conversion. The processor 21 decodes and demodulates the radio signals received through the receive antennas and restores data that the transmitting device 10 wishes to transmit.

The RF units 13 and 23 include one or more antennas. An antenna performs a function of transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

In embodiments of the present invention, a UE serves as the transmission device 10 on uplink and as the receiving device 20 on downlink. In embodiments of the present invention, an eNB serves as the receiving device 20 on uplink and as the transmission device 10 on downlink.

The transmitting device and/or the receiving device may be configured as a combination of one or more embodiments of the present invention.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other. Accordingly, the invention should not be limited to the specific embodiments described herein, but should be accorded the broadest scope consistent with the principles and novel features disclosed herein.

According to an embodiment of the present invention, efficient interference cancellation operation may be expected using information for interference cancellation.

The present invention may be used for a wireless communication apparatus such as a user equipment (UE), a relay and an eNB.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for receiving information for interference cancellation in a wireless communication system, the method performed by a terminal and comprising:
receiving information on an interference configuration set related to characteristics of an interference signal, from a serving base station (BS);
receiving an indicator indicating one interference configuration of the interference configuration set from an interfering BS; and
performing cancellation of the interference signal using the indicated interference configuration,
wherein the interference configuration set is composed of one or more interference configurations each comprising a plurality of fields indicating the characteristics of the interference signal.

2. The method according to claim 1, wherein the interference configuration set is configured per subframe set or per specific frequency resource unit.

3. The method according to claim 1, wherein the interference configuration comprises information on two or more interference signals having different characteristics.

4. The method according to claim 1, wherein the plurality of fields includes a field indicating a null value.

5. The method according to claim 1, further comprising receiving information on a valid time of the indicated interference configuration from the serving BS,
wherein the indicated interference configuration is used to cancel the interference signal only during the valid time.

6. The method according to claim 1, further comprising receiving information on a period in which the indicator is transmitted or information on a subframe in which the indicator is transmitted, from the serving BS.

7. The method according to claim 1, wherein the information on the interference configuration set is received through semi-static signaling.

8. The method according to claim 1, wherein the indicator is received through dynamic signaling.

9. A terminal configured to receive information for interference cancellation in a wireless communication system, the terminal comprising:
a radio frequency (RF) unit; and
a processor configured to control the RF unit,
wherein the processor is configured to receive information on an interference configuration set related to characteristics of an interference signal, from a serving base station (BS), to receive an indicator indicating one interference configuration of the interference configuration set from an interfering BS, and to perform cancellation of the interference signal using the indicated interference configuration, and
wherein the interference configuration set is composed of one or more interference configurations each comprising a plurality of fields indicating the characteristics of the interference signal.

10. The terminal according to claim 9, wherein the interference configuration set is configured per subframe set or per specific frequency resource unit.

11. The terminal according to claim 9, wherein the interference configuration comprises information on two or more interference signals having different characteristics.

12. The terminal according to claim 9, wherein the plurality of fields includes a field indicating a null value.

13. The terminal according to claim 9, wherein the processor is further configured to receive information on a valid time of the indicated interference configuration from the serving BS, and
wherein the indicated interference configuration is used to cancel the interference signal only during the valid time.

14. The terminal according to claim 9, wherein the processor is further configured to receive information on a period in which the indicator is transmitted or information on a subframe in which the indicator is transmitted, from the serving BS.

15. The terminal according to claim 9, wherein the information on the interference configuration set is received through semi-static signaling.

16. The terminal according to claim 9, wherein the indicator is received through dynamic signaling.
